(19) United States
(12) Patent Application Publication
(10) Pub. No.: US 2005/0173835 A1
(43) Pub. Date: Aug. 11, 2005

(54) Method for producing a heat exchanger box

(75) Inventor: Georg Kammler, Stuttgart (DE)

Correspondence Address: FOLEY AND LARDNER;SUITE 500, 3000 K STREET NW, WASHINGTON, DC, 20007, US

(73) Assignee: BEHR GmbH & CO.

(21) Appl. No.: 10/511,267

(22) PCT Filed: May 7, 2003
(86) PCT No.: PCT/EP03/04764

(30) Foreign Application Priority Data
May 31, 2002 (DE) 102 24 296.8

(51) Int. Cl. B29C 45/00

(52) U.S. Cl. 264/328.1

(57) ABSTRACT

The invention relates to a method for producing a plastic heat exchanger box (1) by means of injection moulding. According to the inventive method, an agent is added to the plastic or a method is used to accelerate the crystallisation of the plastic. The invention also relates to a heat exchanger box (1) which is produced according to the inventive method.

The invention relates to a method for producing a heat exchanger box, in particular for a heat exchanger for a motor vehicle, as described in the preamble of claim 1.

Conventional, injection-molded plastic heat exchanger boxes require auxiliary means, such as for example tensioning frames or strips. These have to be inserted into the still-hot plastic heat exchanger box immediately after it has left the injection mold and generally remain in the plastic heat exchanger box until it is fitted to the heat exchanger box base, i.e. until it is pressed together with the box base with the insertion of a seal, since on account of its box-shaped geometry the heat exchanger box would collapse within a very short time without this auxiliary means. This collapse of the plastic heat exchanger boxes would lead to faults during closure, i.e. during pressing to the base.

It is an object of the invention to provide an improved method for producing a heat exchanger box.

This object is achieved by a method having the features of claim 1. Advantageous configurations form the subject matter of the subclaims.

According to the invention, it is possible to produce the plastic heat exchanger boxes more quickly on account of the accelerated crystallization resulting from the addition of an agent (crystallization accelerator) or the use of a method which accelerates the crystallization. The plastic heat exchanger boxes can be removed from the injection mold at temperatures which are still approx. 120° C. and a tensioning frame can then be inserted into the heat exchanger boxes, whereas according to the prior art the plastic heat exchanger boxes have to cool to approx. 80° C. in the injection mold, and consequently the present invention allows significantly faster production with much shorter cycle times and therefore better utilization of the injection molds. Furthermore, the materials properties of the plastic used are improved. For example, stronger parts with a higher impact strength and a higher modulus of elasticity are obtained. Moreover, the internal stresses in the parts are reduced, leading to more stable parts.

According to a first variant, a crystallization accelerator is added to the plastic. In this case, by way of example, it is possible to use carbon black or mineral substances. The crystallization rate is influenced by the size and quantity of the crystallization accelerators added. For example, in particular small particles and a large number of such particles accelerate crystallization to a greater extent than a small number of large particles.

According to a second, alternative variant, physical blowing agents, i.e. in particular the blowing gases N₂ and/or CO₂, are fed under pressure, in particular between 50 and 250 bar, to the plastic. In this case, the blowing agent is supplied at the screw, i.e. during plasticizing of the plastic, upstream of or directly in the injection mold. The blowing agent causes small cells to form in the plastic, thereby compensating for the volumetric shrinkage resulting from cooling of the plastic, and consequently little or no still-plasticized plastic has to be added under pressure. The use of physical blowing agents is appropriate in particular for thin-walled parts.

According to a further, alternative variant, chemical blowing agents are added to the plastic. These may be blowing agents with an exothermic, i.e. heat-generating, or endothermic, i.e. heat-withdrawing, action. In this case, exothermic blowing agents are generally used at a pressure of 5 to 30 bar, whereas the pressures are lower for endothermic blowing agents. A chemical reaction usually produces CO₂ as blowing gas. A blowing agent in the form of granules enrobed with polyethylene can preferably be used as blowing agent and is admixed with the plastic granules prior to plasticizing in the injection-molding machine. Examples of suitable blowing agents include azo or diazo compounds. On account of the simplicity of admixing and the fact that few if any changes need to be made to the injection-molding machines, the costs of the installation are lower than if physical blowing agents are used.

It is preferable for the relaxation, i.e. the expansion, to be accelerated, so that the plastic heat exchanger boxes are more stable during further processing, i.e. during the removal of the tensioning frames and the insertion into the box bases, i.e. relaxation is then slower. Within the temperature ranges which prevail, an increase in temperature by 10° K. increases the relaxation rate by more than a factor of two.

The plastic is preferably polyamide, polyphenylene sulfide or polypropylene, the plastic preferably being reinforced with glass fibers.

According to the invention, the heat exchanger box is removed from the injection mold at a higher surface temperature than in the prior art (approx. 80° C.), in particular at a surface temperature of 120°±10° C. In this case, an auxiliary tensioning means, for example a tensioning frame, which if appropriate may also be cooled, is inserted immediately after the heat exchanger box has been removed from the injection mold.

The text which follows provides a detailed explanation of the invention on the basis of an exemplary embodiment and with reference to the drawing, in which:

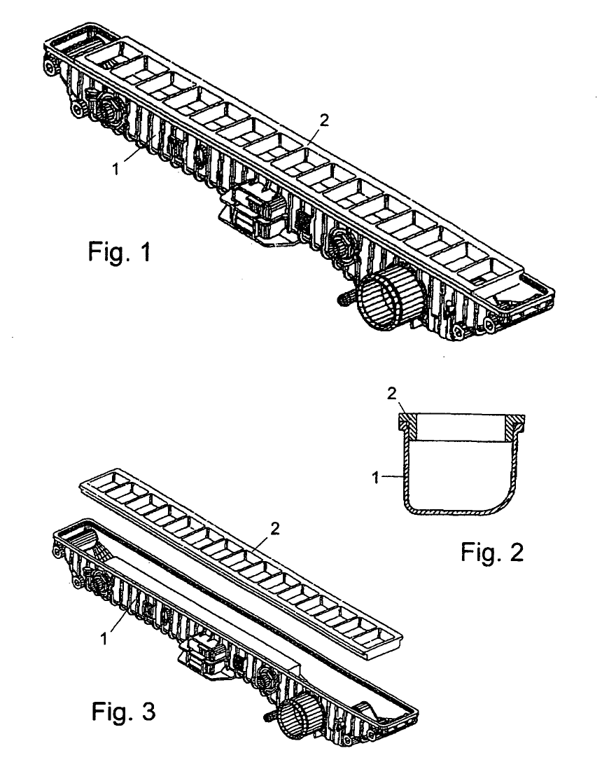

FIG. 1 shows a heat exchanger box with inserted tensioning strip,

FIG. 2 shows a section through FIG. 1, and

FIG. 3 shows the heat exchanger box and the tensioning strip separately.

A heat exchanger box 1 according to the invention of an air-conditioning system of a motor vehicle consists of polyamide reinforced with glass fibers. To produce the heat exchanger box 1, a chemical, exothermic blowing agent in granule form, the blowing agent being enrobed with polyethylene, is added to a polyamide which is in granule form and has been mixed with glass fibers in order to accelerate the crystallization, then the two sets of granules are mixed with one another and are fed to an injection-molding machine.

The granules are plasticized in a known way in a screw of the injection-molding machine to produce a plastics compound under the action of heat (240-290° C.) and pressure. This plastics compound, in a plasticized state, is introduced into an injection mold. On account of high temperatures, the blowing agent reacts, releasing thermal energy, to form CO₂. The blowing agent or the CO₂ which is formed is responsible for faster filling of the injection mold, since there is less volumetric shrinkage of the plastic compound during cooling, and consequently no or only a minimal quantity of plasticized plastics compound has to be topped up to compensate for the volumetric shrinkage.

The plastics compound remains in the injection mold until the mold has been filled and a certain degree of crystallization and relaxation has occurred. Then, the injection mold is opened, the heat exchanger box 1 is removed and a tensioning frame 2 is inserted immediately in order to prevent the heat exchanger box 1 from collapsing. According to the method of the invention, the heat exchanger box 1 is at a surface temperature of approx. 120° C. when it is removed. The tensioning frame 2 may be cooled.

For further processing, an elastic rubber seal is placed around an aluminum box base, the tensioning frame 2 is removed from the heat exchanger box 1, and as quickly as possible, i.e. within approx. 30-60 seconds, the heat exchanger box 1 is placed onto the aluminum box base with elastic rubber seal and the two parts are pressed together in a press.

1. A method for producing a heat exchanger box (1) from plastic by means of injection molding, characterized in that an agent is added or a method is used which in each case accelerates the crystallization of the plastic.

2. The method as claimed in claim 1, characterized in that a crystallization accelerator is added to the plastic.

3. The method as claimed in claim 1, characterized in that an exothermic or endothermic chemical foaming method or a physical foaming method is used.

4. The method as claimed in claim 3, characterized in that pressurized CO₂ and/or N₂ is supplied as physical blowing agent or CO₂ is generated as chemical blowing agent.

5. The method as claimed in claim 3, characterized in that polyethylene-enrobed granules are admixed as chemical blowing agent with the plastic prior to injection molding.

6. The method as claimed in claim 1, characterized in that the relaxation is accelerated.

7. The method as claimed in claim 1, characterized in that the plastic is polyamide, polyphenylene sulfide or polypropylene.

8. The method as claimed in claim 1, characterized in that the plastic is reinforced with glass fibers.

9. The method as claimed in claim 1, characterized in that the heat exchanger box (1) is removed from the injection mold at a surface temperature of over 80° C.

10. The method as claimed in claim 1, characterized in that the heat exchanger box (1) is removed from the injection mold at a surface temperature of 120°±10° C.

11. The method as claimed in claim 1, characterized in that an auxiliary tensioning means (2) is inserted immediately after the heat exchanger box (1) has been removed from the injection mold.

12. A heat exchanger box (1) made from plastic, characterized in that the heat exchanger box (1) is produced using the method as claimed in claim 1.
